(19) United States
(12) Patent Application Publication
(10) Pub. No.: US 2003/0072703 A1
(43) Pub. Date: Apr. 17, 2003

(54) Method for removing the harmful effects of organic halogen compound gas, apparatus for removing the harmful effects of organic halogen compound gas, system for fabricating semiconductor devices, and method for fabricating semiconductor devices

(76) Inventor: Toshikazu Sugiura, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/242,327

(22) Filed: Sep. 12, 2002

(30) Foreign Application Priority Data
Sep. 13, 2001 (JP) 2001-277885
Sep. 12, 2002 (JP) 2002-266977

(51) Int. Cl. C01B 7/00

(52) U.S. Cl. 423/241

(57) ABSTRACT

The invention provides a method for removing the harmful effects of organic halogen compound gas, in which an organic halogen compound gas (20) discharged by a production unit (8) is transferred into an organic halogen compound-decomposing unit (4) via an adsorbing part (6) that contains an adsorbent (60), followed by decomposing the organic halogen compound gas (20) in the organic halogen compound-decomposing unit (4), and provides an apparatus for removing the harmful effects of organic halogen compound gas, a system for fabricating semiconductor devices, and a method for fabricating semiconductor devices.

### FIELD OF THE INVENTION

The present invention relates to a method for removing the harmful effects of organic halogen compound gas discharged by apparatus used for fabricating semiconductor devices, to an apparatus for removing the harmful effects of organic halogen compound gas, to a system for fabricating semiconductor devices, and to a method for fabricating semiconductor devices.

### BACKGROUND ART

FIG. 11 is a schematic view showing a system for fabricating semiconductor devices that includes a conventional apparatus for removing the harmful effects of organic halogen compound gas.

The apparatus for removing the harmful effects of organic halogen compound gas includes an organic halogen compound-decomposing unit 104. The organic halogen compound-decomposing unit 104 is for decomposing organic halogen compound gas such as perfluoro compound gas (hereinafter referred to as PFC gas) including, for example, CF₄, C₂F₆, NF₃, C₃F₈, C₄F₈, CHF₃ and SF₆ that may be discharged by a production unit 8 such as a CVD (chemical vapor deposition) unit or an etching unit after the production treatment therein, to thereby remove the harmful effects of the organic halogen compound gas.

The global warming potential (GWP) of organic halogen compound gas such as PFC gas is very large, thousands to tens of thousands of times that of carbon dioxide. Therefore, when the gas is directly discharged out, its influence on the global environment is said to be serious. Accordingly, the recent tendency is toward regulating the direct discharge of organic halogen compound gas into the air.

The production unit 108 that uses organic halogen compound gas therein is equipped with an exhaust pipe 101 through which exhaust gas including the used organic halogen compound gas is discharged. The exhaust pipe 101 is connected to a dry pump 102, and the dry pump 102 is connected to an exhaust pipe 103. Accordingly, the exhaust pipe 101 is connected to the transfer pipe 103 via the dry pump 102. The transfer pipe 103 is connected to the organic halogen compound-decomposing unit 104. The organic halogen compound-decomposing unit 104 is connected to another exhaust pipe 105, and the exhaust pipe 105 runs outside the factory.

Next described is the operation of the above-mentioned, conventional organic halogen compound-decomposing unit 104.

The organic halogen compound gas used in the production unit 108 is led into the exhaust pipe 101 by the dry pump 102, and then into the organic halogen compound-decomposing unit 104 via the exhaust pipe 103. Thus led thereinto, the organic halogen compound gas is decomposed in the organic halogen compound-decomposing unit 104 and its harmful effects are thereby removed. With that, the resulting harmless exhaust gas is then discharged out of the factory via the exhaust pipe 105.

Various types of organic halogen compound gas-decomposing units are known, for example, chemical-type, catalyst-type, combustion-type and plasma-type systems. Of those, the plasma-type system specifically requires radio frequency power (RF power). As in FIG. 10, the organic halogen compound gas concentration varies in proportion to the radio frequency power (RF power) of the system, and the organic halogen compound gas concentration may have a curved profile. In other systems than the plasma-type system, the organic halogen compound gas concentration may also show a curved profile when the gas is led into or out of the production unit 108. To that effect, the organic halogen compound gas concentration may vary in accordance with the sequence of the production unit 108. In that case, an organic halogen compound gas flow of which the concentration has a curved profile will flow into the organic halogen compound-decomposing unit 104.

Since the organic halogen compound gas to be processed has such a curved concentration change profile, the organic halogen compound-decomposing unit 104 must be so designed and selected that its ability to decompose organic halogen compound gas is enough to process the gas concentration at the highest point of the curved profile (hereinafter referred to as the maximum concentration) of the gas.

In addition, when an organic halogen compound gas is decomposed, the ability of the organic halogen compound-decomposing unit 104 for it must be such that the unit can decompose organic halogen compound gas of the maximum concentration. If not, the unit could not make exhaust gas harmless. Accordingly, the power of the organic halogen compound-decomposing unit 104 must be determined in accordance with the maximum concentration of the organic halogen compound gas to be processed in the unit, or a high-performance unit must be selected for decomposing the gas.

In the case where the power of the organic halogen compound-decomposing unit 104 is determined in accordance with the maximum concentration of the organic halogen compound gas to be processed in the unit, the unit requires excess energy and its energy efficiency will decrease. In the other case where a high-power gas-decomposing unit is used, it increases the cost of factory equipment. In addition, some types of the production unit 108 can not be equipped with the organic halogen compound-decomposing unit 104 if the maximum concentration of the organic halogen compound gas to be processed in the unit 104 is too high.

The present invention has been made in consideration of the above-mentioned situation, and its object is to provide a method for removing the harmful effects of organic halogen compound gas by decomposing the gas, which is specifically so designed that the maximum concentration of the organic halogen compound gas discharged by a production apparatus is lowered before the gas reaches an organic halogen compound-decomposing unit to be used in the method. It also provides an apparatus for the method of removing the harmful effects of organic halogen compound gas, a system for fabricating semiconductor devices, and a method for fabricating semiconductor devices.

### DISCLOSURE OF THE INVENTION

The method of the invention for removing the harmful effects of organic halogen compound gas is for decomposing the organic halogen compound gas discharged by a production unit to thereby make the gas harmless, and the method comprises introducing the organic halogen compound gas from the production unit into an adsorbing part that contains an adsorbent, and then into an organic halogen compound-decomposing unit to thereby decompose the gas in the organic halogen compound-decomposing unit.

The apparatus of the invention for removing the harmful effects of organic halogen gas compound comprises an organic halogen compound gas-decomposing unit in which the organic halogen compound gas having been discharged by a production unit is decomposed, and an adsorbing part that contains an adsorbent and is placed between the production unit and the organic halogen compound-decomposing unit in the path of the organic halogen compound gas flow.

The method of the invention for fabricating semiconductor devices comprises a step of decomposing the organic halogen compound gas discharged by a semiconductor device-fabricating unit to make the gas harmless, and is characterized in that the organic halogen compound gas from the semiconductor device-fabricating unit is led into an adsorbing part that contains an adsorbent, and then into an organic halogen compound-decomposing unit to thereby decompose the gas in the gas-decomposing unit.

The system of the invention for fabricating semiconductor devices comprises a semiconductor device-fabricating unit that discharges organic halogen compound gas, an organic halogen compound-decomposing unit for decomposing the organic halogen compound gas, and an adsorbing part that contains an adsorbent and is placed between the semiconductor device-fabricating unit and the organic halogen compound-decomposing unit in the path of the organic halogen compound gas flow.

By using the apparatus for removing the harmful effects of organic halogen compound gas, the system that comprises it for fabricating semiconductor devices, the method for removing the harmful effects of organic halogen compound gas and the method that comprises it for fabricating semiconductor devices, the adsorbent in the adsorbing part physically adsorbs the organic halogen compound gas from the production unit, and it gradually releases the thus-adsorbed organic halogen compound gas to control the released organic halogen compound gas concentration to a predetermined level so as to flatten the fluctuating concentration profile of the gas to be processed in the gas-decomposing unit. In that manner, the organic halogen compound gas discharged by the production unit is led into the adsorbent-containing adsorbing part before it is led into the organic halogen compound gas-decomposing unit. Thus the maximum concentration of the organic halogen compound gas to be led into the decomposing unit can be lowered. Accordingly, even an organic halogen compound-decomposing unit of low power that guarantees a low concentration of gas to be decomposed therein can be used in the invention, and the latitude of the invention in selecting the organic halogen compound-decomposing unit to be used is broadened. To that effect, the invention has made it possible to broaden the applicability of any type of organic halogen compound-decomposing unit to the invention. In the invention, in addition, it is unnecessary to specifically determine the power of the organic halogen compound-decomposing unit to be used in accordance with the maximum concentration of the gas to be processed in the unit. In the invention, operation of the organic halogen compound-decomposing unit may be conducted such that power and reaction gas flow rate are adjusted to the maximum concentration of the flattened concentration profile of the organic halogen compound gas to be processed. Accordingly, the energy consumption in the invention can be reduced.

### BRIEF DESCRIPTION OF THE DRAWINGS

FIG. 1 is a conceptual diagram showing a system for fabricating semiconductor devices, which includes an apparatus for removing the harmful effects of organic halogen compound gas of one embodiment of the invention.

FIG. 2 is a conceptual diagram showing a system for fabricating semiconductor devices, which includes an apparatus for removing the harmful effects of organic halogen compound gas of another embodiment of the invention.

FIG. 3 is a conceptual diagram showing a system for fabricating semiconductor devices, which includes an apparatus for removing the harmful effects of organic halogen compound gas of still another embodiment of the invention.

FIG. 4 is a conceptual diagram showing a system for fabricating semiconductor devices, which includes an apparatus for removing the harmful effects of organic halogen compound gas of still another embodiment of the invention.

FIG. 5 is a conceptual diagram showing a system for fabricating semiconductor devices, which includes an apparatus for removing the harmful effects of organic halogen compound gas of still another embodiment of the invention.

FIG. 6 is a graph to comparatively show the organic halogen compound gas concentration profiles vs. time in an organic halogen compound-processing apparatus, in which organic halogen compound gas is led into the organic halogen compound-decomposing unit after having been passed through an adsorbent (solid line) in one case, and not being passed through it (dotted line) in another case.

FIG. 7 is a conceptual diagram showing one example of the adsorbing unit in one embodiment of the invention.

FIG. 8 is a conceptual diagram showing another example of the adsorbing unit in one embodiment of the invention.

FIG. 9 is a conceptual diagram showing a modification of the system for fabricating semiconductor devices of any of FIGS. 1 to 4, which includes an apparatus for removing the harmful effects of organic halogen compound gas.

FIG. 10 is a graph to show the organic halogen compound gas concentration profile in a plasma-type organic halogen compound-decomposing unit vs. the RF power of the unit.

FIG. 11 is a conceptual diagram showing a system for fabricating semiconductor devices, which includes a conventional apparatus for removing the harmful effects of organic halogen compound gas.

### BEST MODES OF CARRYING OUT THE INVENTION

Embodiments of the invention are described hereinunder with reference to the drawings.

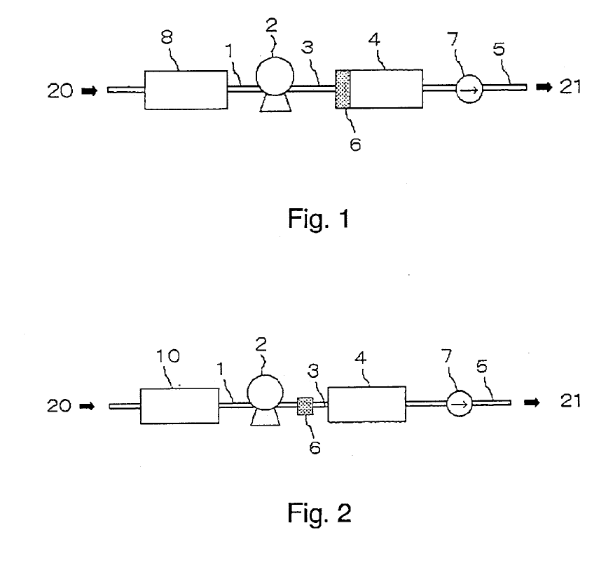

FIG. 1 to FIG. 4 are conceptual diagram each showing a system for fabricating semiconductor devices, which includes an apparatus for removing the harmful effects of organic halogen compound gas of any one embodiment of the invention.

The production unit 8 uses an organic halogen compound gas 20 for production treatment. For example, the production unit 8 includes a CVD unit and an etching unit, and it discharges the organic halogen compound gas 20 after used therein for various treatments.

The organic halogen compound gas 20 is, for example, perfluoro compound gas (hereinafter referred to as PFC gas) typically including CF₄, C₂F₆, NF₃, C₃F₈, C₄F₈, CHF₃ and SF₆.

The apparatus for removing the harmful effects of organic halogen compound gas has at least an organic halogen compound gas-decomposing unit 4 and an adsorbing part 6 in the path of the flow of the organic halogen compound gas 20. The adsorbing part 6 is placed in the path of the flow of the organic halogen compound gas 20 and before the organic halogen compound-decomposing unit 4.

The organic halogen compound-decomposing unit 4 is to decompose the organic halogen compound gas 20 that has been discharged by the production unit 10, to remove the harmful effects of the gas 20, and it discharges a processed gas 21. The organic halogen compound-decomposing unit 4 may be any of chemical-type, catalyst-type, combustion-type and plasma-type decomposing units. In the plasma-type organic halogen compound-decomposing unit 4, the organic halogen compound gas 20 is activated with plasma, and then chemically reacted with a reactive gas to give a reaction product, and the resulting reaction product of the thus-activated organic halogen compound gas 20 with the reactive gas is removed. For example, a single gas of O₂ or H₂O or a mixed gas of them that serves as a reactive gas is introduced into a plasma-type PFC-decomposing unit, and this is reacted with the PFC gas in the unit while exposed to plasma therein, thereby decomposing the PFC gas.

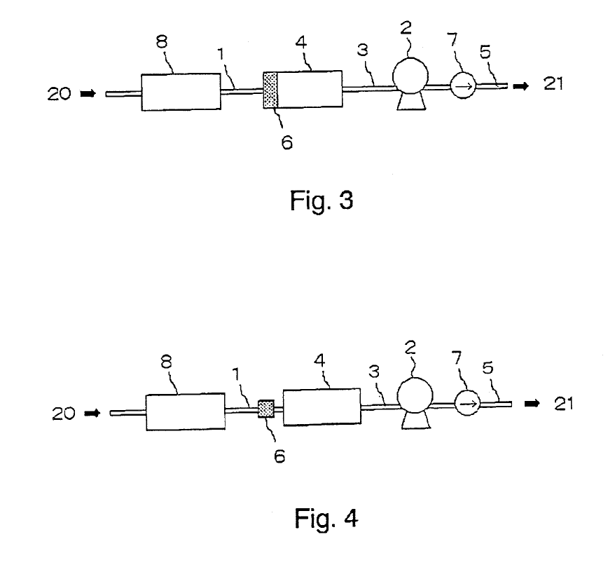

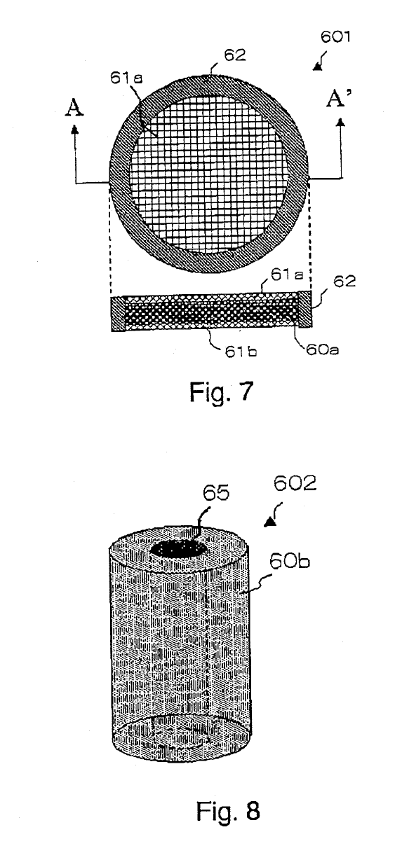

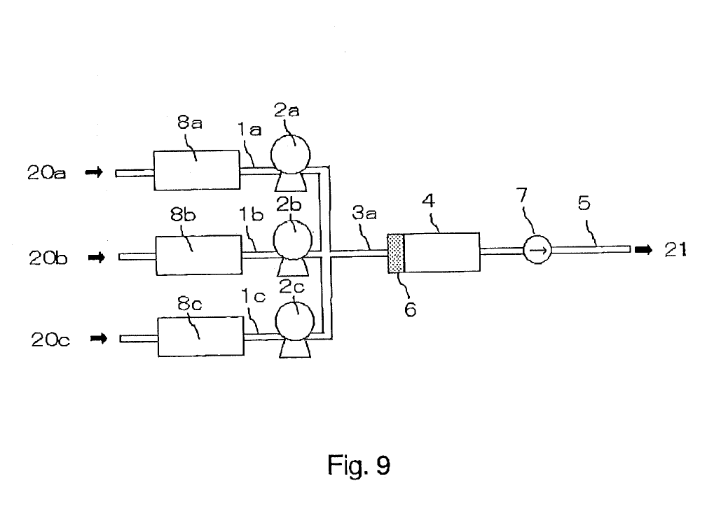

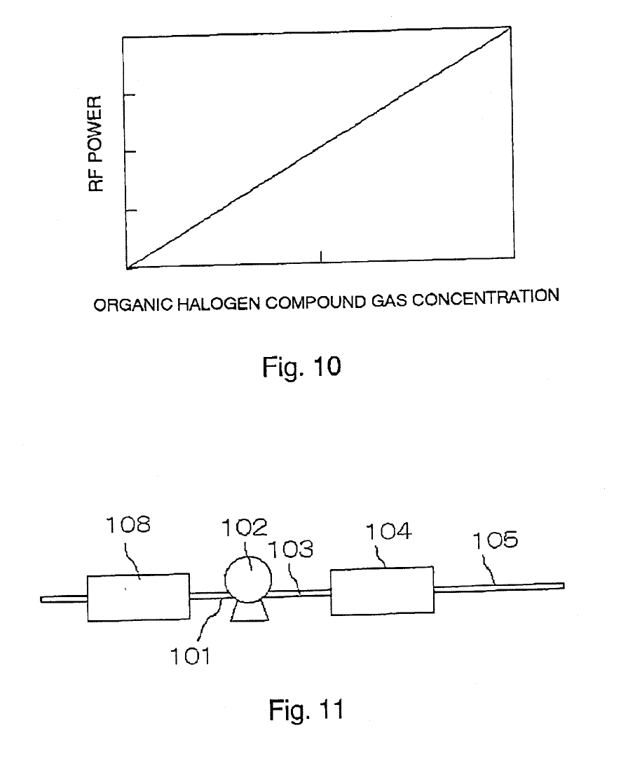

The adsorbing part 6 contains an adsorbent 60. The adsorbent 60 temporarily adsorbs the organic halogen compound gas 20 and gradually releases it to the subsequent stages. The adsorbent 60 contains at least a substance having the property of physically adsorbing the gaseous molecules of the organic halogen compound gas 20. Having the property, any and every substance may be in the adsorbent. For example, the adsorbent 60 may be a porous material such as zeolite, activated charcoal, porous ceramics. Containing at least the adsorbent 60, the adsorbing part 6 may be in any form. For example, the adsorbing part 6 may be in the form of a cylindrical filter 602 that contains an adsorbent 60b, as in FIG. 8. In this case, the filter 602 may have a hollow structure with a through-hole 65 formed, as in FIG. 8. In addition, the adsorbing part 6 may be in the form of a filter 601 having an adsorbent 63 sandwiched between a pair of facing gas-pervious layers 61a, 61b therein, as in FIG. 7. In this case, a frame 62 may be provided to surround the filter so as to make it easy to fit the adsorbing part 6 in the apparatus. As in FIG. 7, the adsorbent 60a may be granular or powdery. In this case, the area in which the organic halogen compound gas 20 is brought into contact with the adsorbent 60a can be enlarged to ensure effect adsorption. As in FIGS. 1 and 3, the adsorbing part 6 may be placed adjacent to the organic halogen compound-decomposing unit 4, or may be inside the organic halogen compound-decomposing unit 4. On the other hand, as in FIGS. 2 and 4, the adsorbing part 6 may be separated from the organic halogen compound-decomposing unit 4. In this case, the organic halogen compound -decomposing unit 4 is connected to the adsorbing part 6 via an exhaust pipe.

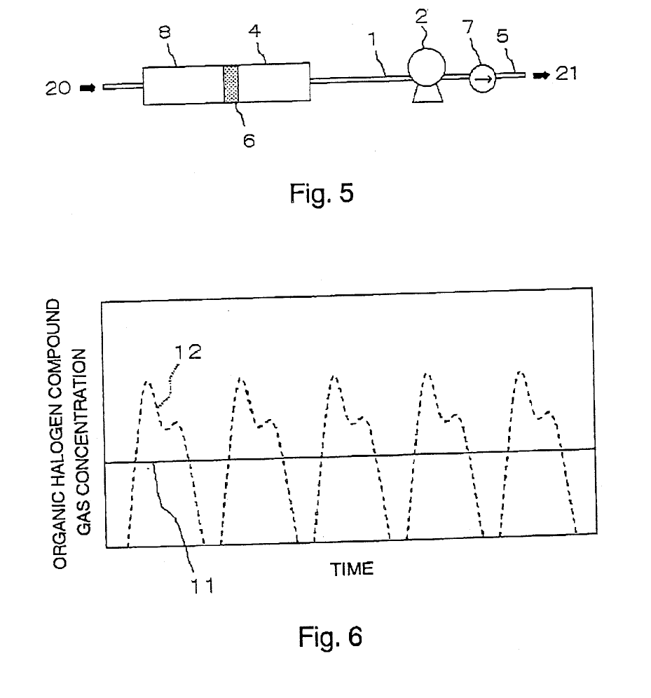

The organic halogen compound gas 20 having been discharged by the production unit 8 passes through the adsorbing part 6 that contains the adsorbent 60 to adsorb the organic halogen compound gas 20, and then this is led into the organic halogen compound-decomposing unit 4. As in FIGS. 1 to 4, the production unit 8 may be connected to the organic halogen compound-decomposing unit 4 via an exhaust pipe. In this case, the organic halogen compound gas 20 discharged by the production unit 8 passes through the exhaust pipe and enters the organic halogen compound-decomposing unit 4. On the other hand, the organic halogen compound-decomposing unit 4 may be integrated with the production unit 8, as in FIG. 5. In the embodiments of FIGS. 1 to 4, an exhaust pipe 1 is fitted to the production unit 8, through which the exhaust gas that contains the used organic halogen compound gas 20 from the production unit 8 is led to the next stage. A dry pump 2 may be connected to the exhaust pipe before the organic halogen compound-decomposing unit 4 in the path of the exhaust gas flow as in the embodiments of FIGS. 1 and 2, or may be connected to the exhaust pipe after the organic halogen compound-decomposing unit 4 therein as in the embodiments of FIGS. 3 and 4. In the embodiment of FIG. 1, the exhaust pipe 1 is connected to the dry pump 2, and the dry pump 2 is connected to a transfer pipe 3. Accordingly, the exhaust pipe 1 is connected to the exhaust pipe 3 via the dry pump 2 therebetween. By the action of the dry pump 2, the pressure inside the exhaust pipe before the dry pump 2 (inside of the exhaust pipe 1 in FIG. 1) is kept lower than that inside the exhaust pipe after the dry pump 2 (inside of the exhaust pipe 3 in FIG. 1) in the path of the exhaust gas flow. In the path of the exhaust gas flow, the exhaust pipe connected before the dry pump 2 may be kept in vacuum or almost in vacuum, and the exhaust pipe after the dry pump 2 may have an atmospheric pressure. The organic halogen compound gas 20, which is decomposed in the organic halogen compound-decomposing unit 4, becomes a processed gas 21, which is then discharged out of the factory via the exhaust pipe 5. The exhaust pipe 5 runs outside the factory. For letting the processed gas 21 outside, a gas transfer unit 7 such as a pump or valve may be additionally fitted in the exhaust pipe 5.

Next described is a method for decomposing organic halogen compound gas by the use of the organic halogen compound-decomposing unit 4. This may be applied also to fabrication of semiconductor devices.

In the production unit 8 such as a CVD unit or etching unit, an organic halogen compound gas 20 is used for production treatment. In case where the organic halogen compound-decomposing method is applied to fabrication of semiconductor devices, the production unit 8 is to be the apparatus for fabricating semiconductor devices. The organic halogen compound gas 20 thus used in the production unit 8 is led into the organic halogen compound-decomposing unit 4 via the adsorbing part 6, and the organic halogen compound gas 20 is decomposed in the unit 4 to thereby remove the harmful effects of the gas 20. The organic halogen compound gas 20 in the production unit 8 is led into the exhaust pipe 1 by the dry pump 2. Next, the thus-led organic halogen compound gas is then led into the adsorbent 6 via the transfer pipe 3. The PFC gas thus having flowed thereinto is trapped in the adsorbent 6, and gradually flows into the organic halogen compound-decomposing unit 4 of the subsequent stage. Accordingly, even when an organic halogen compound gas 20 of high concentration has flowed out at a time from the production unit 8, the concentration profile of the organic halogen compound gas 20 can be flattened in some degree in the adsorbing part 6, and the gas 20 can be gradually led into the organic halogen compound-decomposing unit 4 of the subsequent stage. Therefore, the maximum concentration of the gas 20 to be processed in the organic halogen compound-decomposing unit 4 can be lowered. In other words, the maximum amount of the organic halogen compound gas to be decomposed in the unit 4 per unit time can be reduced.

Now, the case in which the organic halogen compound gas 20 is led into the organic halogen compound-decomposing unit 4 through the adsorbing part 6 is compared with a case in which the organic halogen compound gas 20 is led into the organic halogen compound-decomposing unit 4 not through the adsorbing part 6. FIG. 6 shows the concentration profile of the organic halogen compound gas 20 vs. time, comparing the two cases. In this, the solid line 11 indicates the case in which the gas 20 has passed through the adsorbing part 6, and the dotted line 12 indicate the case in which the gas 20 has not passed through it. As in FIG. 6, the total amount of the organic halogen compound gas 20 to be decomposed is the same in the two cases. However, as compared with that in the case in which the gas 20 has not passed through the adsorbing part 6, the maximum amount (the maximum instantaneous amount) of the organic halogen compound gas to be decomposed in the case in which the gas 20 has passed through the adsorbing part 6 is reduced. Passing the organic halogen compound gas 20 through the adsorbing part 6 makes it possible to flatten the concentration profile of the gas 20. The concentration of the organic halogen compound gas 20 that has passed through the adsorbing part 6 can be kept almost constant.

The organic halogen compound gas 20 of which the concentration is kept almost constant is led into the organic halogen compound-decomposing unit 4 and is decomposed therein into a harmless processed gas 21. The exhaust gas that contains the harmless processed gas 21 passes through the exhaust pipe 5 and is discharged out of the factory. Using the organic halogen compound-decomposing unit 4, organic halogen compounds are decomposed, or the production treatment by semiconductor equipment is conducted.

According to the embodiments mentioned above, the organic halogen compound gas 20 that flows into the organic halogen compound-decomposing unit 4 in accordance with the sequence of the production unit 8 is passed through the adsorbing part 6 placed between the production unit 8 and the organic halogen compound-decomposing unit 4 in the path of the gas flow, whereby the concentration of the organic halogen compound gas 20 to be led into the unit 4 can be kept constant in some degree and the concentration profile of the organic halogen compound gas 20 to be led into the unit 4 can be flattened. Accordingly, the maximum concentration (the maximum concentration) of the organic halogen compound gas to be processed in the unit 4 can be reduced. Therefore, even a low-power unit that guarantees a low concentration of organic halogen compound gas to be decomposed therein can be selected for use in the invention, and the latitude of the invention in selecting organic halogen compound-decomposing units employable therein is broadened. Thus, the invention broadens the application range of organic halogen compound-decomposing units. In addition, the invention requires neither the power of the organic halogen compound-decomposing unit be set specifically in accordance with the maximum concentration of the organic halogen compound gas to be processed in the unit, nor that the amount of the reactive gas to be used in the unit be specifically controlled in response to the maximum concentration level. The invention has made it possible to drive the organic halogen compound-decomposing unit at any power that corresponds to the flattened concentration profile of organic halogen compound gas, using any amount of the reactive gas also corresponding to it, and the invention saves any excess material and energy.

FIG. 3 is a conceptual diagram showing a modification of the system for fabricating semiconductor devices of any of FIGS. 1 to 4, which includes an apparatus for removing the harmful effects of organic halogen compound gas. In this conceptual diagram, the parts which are the same as in FIGS. 1 to 4 are indicated by the same reference numerals as in FIGS. 1 to 4, and only the parts that differ from those in FIGS. 1 to 4 are described below.

In this modification, the organic halogen compound gases 20a to 20c in the exhaust gas discharged by multiple production units 8a to 8c are decomposed in the organic halogen compound-decomposing unit 4.

For example, the multiple production units 8a, 10b and 10c, which use organic halogen compound gases 20a, 20b and 20c, respectively, are connected to exhaust pipes 1a, 1b and 1c, respectively, through which the exhaust gas that contains any of the used organic halogen compound gases 20a to 20c. These exhaust pipes 1a, 1b and 1c are connected to dry pumps 2a, 2b and 2c, respectively, and these dry pumps are connected to a transfer pipe 3a. The transfer pipe 3a is connected to one adsorbing part 6 so that the organic halogen compound gases 20a to 20c discharged by the multiple production units 10a, 10b and 10c are led into one adsorbing part 6 and to one organic halogen compound-decomposing unit 4. All the conceptual drawings mentioned above may be applied to these adsorbing part 6 and organic halogen compound-decomposing unit 4.

The modification also produces the same results as those produced by the above-mentioned embodiments.

The invention is not limited to the embodiments mentioned above, and the embodiments may be changed and modified in any desired manner for carrying out the invention. For example, in the above-mentioned modification, three production units 8a to 10c are connected to one adsorbing part 6. Apart from this, two or four or more multiple production units may be connected to one adsorbing part.

According to the invention, organic halogen compound gas is physically adsorbed by the adsorbent in an adsorbing part, and the thus-adsorbed organic halogen compound gas is gradually released. Accordingly, in the invention, the maximum concentration of the organic halogen compound gas to be discharged by a production unit can be reduced, and the concentration profile of the discharged organic halogen compound gas can be flattened more. Therefore, in the invention, the organic halogen compound gas discharged by a production unit can be efficiently decomposed to remove its harmful effects.

What is claimed is:

1. A method for removing harmful effects of organic halogen compound gas discharged by a production unit through the use of an organic halogen compound-decomposing unit, whereby
the organic halogen compound gas is led from the production unit into the organic halogen compound-decomposing unit via an adsorbing part that contains an adsorbent, and the organic halogen compound gas is decomposed in the organic halogen compound-decomposing unit.

2. The method for removing the harmful effects of organic halogen compound gas as claimed in claim 1,
wherein the adsorbent is a porous material.

3. The method for removing the harmful effects of organic halogen compound gas as claimed in claim 1,
wherein the adsorbent is any of zeolite, activated charcoal and porous ceramics.

4. The method for removing the harmful effects of organic halogen compound gas as claimed in claim 1,
wherein the adsorbent is powdery or granular.

5. The method for removing the harmful effects of organic halogen compound gas as claimed in claim 1,
wherein any of chemical-type, catalyst-type, combustion-type or plasma-type decomposing units is used in the step of decomposing the organic halogen compound gas.

6. The method for removing the harmful effects of organic halogen compound gas as claimed in claim 1,
wherein the adsorbing part is placed between the production unit and the organic halogen compound-decomposing unit in the path of the organic halogen compound gas flow.

7. An apparatus for removing the harmful effects of organic halogen compound gas , which comprises;
an organic halogen compound-decomposing unit in which the organic halogen compound gas having been discharged by a production unit is decomposed, and
an adsorbing part that contains an adsorbent and is placed between the production unit and the organic halogen compound-decomposing unit in the path of the organic halogen compound gas flow.

8. The apparatus for removing the harmful effects of organic halogen gas compound as claimed in claim 7,
wherein the adsorbent is a porous material.

9. The apparatus for removing the harmful effects of organic halogen gas compound as claimed in claim 7,
wherein the adsorbent is any one of zeolite, activated charcoal and porous ceramics.

10. The apparatus for removing the harmful effects of organic halogen gas compound as claimed in claim 7,
wherein the exhaust gas-decomposing unit is any one of chemical-type, catalyst-type, combustion-type or plasma-type decomposing units.

11. A method for fabricating semiconductor devices, in which the organic halogen compound gas discharged by the unit of fabricating semiconductor devices is decomposed in an organic halogen compound-decomposing unit to thereby make the gas harmless, whereby;
the organic halogen compound gas is led from the semiconductor device-fabricating unit into the organic halogen compound-decomposing unit via an adsorbing part that contains an adsorbent, and
the organic halogen compound gas is decomposed in the organic halogen compound-decomposing unit.

12. The method for fabricating semiconductor devices as claimed in claim 11,
wherein the adsorbent is a porous material.

13. The method for fabricating semiconductor devices as claimed in claim 11,
wherein the adsorbent is powdery or granular.

14. The method for fabricating semiconductor devices as claimed in claim 11,
wherein the semiconductor device-fabricating unit is a CVD unit or an etching unit.

15. The method for fabricating semiconductor devices as claimed in claim 11,
wherein the adsorbing part is placed between the semiconductor device-fabricating unit and the organic halogen compound-decomposing unit in the path of the organic halogen compound gas flow.

16. A system for fabricating semiconductor devices, which comprises;
a semiconductor devicefabricating unit that discharges organic halogen compound gas,
an organic halogen compound-decomposing unit for decomposing the organic halogen compound gas, and
an adsorbing part that contains an adsorbent and is placed between the semiconductor device-fabricating unit and the organic halogen compound-decomposing unit in the path of the organic halogen compound gas flow.

17. The system for fabricating semiconductor devices as claimed in claim 16,
wherein the adsorbent is a porous material.

18. The system for fabricating semiconductor devices as claimed in claim 16,
wherein the adsorbent is any one of zeolite, activated charcoal and porous ceramics.

19. The system for fabricating semiconductor devices as claimed in claim 16,
wherein the exhaust gas-decomposing unit is any one of chemical-type, catalyst-type, combustion-type or plasma-type decomposing units.

20. The system for fabricating semiconductor devices as claimed in claim 16,
wherein the semiconductor device-fabricating unit is a CVD unit or an etching unit.
